(19) United States
(12) Patent Application Publication
(10) Pub. No.: US 2006/0213251 A1
(43) Pub. Date: Sep. 28, 2006

(54) Carbon nanotube films for hydrogen sensing

(75) Inventors: Andrew Gabriel Rinzler, Newberry, FL (US); Jennifer Ann Sippel-Oakley, Gainesville, FL (US); Byoung S. Kang, Gainesville, FL (US); Hung-Ta Wang, Gainesville, FL (US); Fan Ren, Gainesville, FL (US); Stephen J. Pearton, Gainesville, FL (US)

Correspondence Address: AKERMAN SENTERFITT, P.O. BOX 3188, WEST PALM BEACH, FL, 33402-3188, US

(73) Assignee: University of Florida Research Foundation, Inc.

(21) Appl. No.: 11/089,311

(22) Filed: Mar. 24, 2005

(51) Int. Cl. G01N 7/00

(52) U.S. Cl. 73/23.2

(57) ABSTRACT

A multi-layer H₂ sensor includes a carbon nanotube layer, and a ultra-thin metal or metal alloy layer in contact with the nanotube layer. The ultra-thin metal or metal alloy layer is preferably from 10 to 50 angstroms thick. An electrical resistance of the layered sensor increases upon exposure to H₂ and can provide detection of hydrogen gas (H₂) down to at least 10 ppm, The metal or metal alloy layer is preferably selected from the group consisting of Ni, Pd and Pt, or mixtures thereof. Multi-layered sensors and can be conveniently operated at room temperature.

### STATEMENT REGARDING FEDERALLY SPONSORED RESEARCH OR DEVELOPMENT

The U.S. government may have certain rights to the invention based on AFOSR grant number F49620-03-1-0370; NSF(CTS-0301178), NASA Kennedy Space Center Grant NAG 10-316, ONR (N00014-98-1-02-04), and NSF DMR 0400416.

### CROSS-REFERENCE TO RELATED APPLICATIONS

Not applicable.

### FIELD OF THE INVENTION

The invention relates to multi-layer hydrogen sensors which include a carbon nanotube layer.

### BACKGROUND

Ongoing efforts towards a hydrogen-based transportation economy have stimulated an increased need for compact, reliable, low cost, low power consumption hydrogen sensors for monitoring and safety. These are also required for spacecraft powered by hydrogen fuel cells where long-duration space flights can last for years and potentially decades.

Single walled carbon nanotubes (SWNTs) have exhibited a charge transport sensitivity to their chemical environment, making them attractive for chemical sensing applications. In one paper (Y. Lu, J. Li, H. T. Ng, C. Binder, C. Partridge, M. Meyyapan, Chem. Phys. Lett. 391, 344 (2004), a group of researchers showed that by palladium loading the nanotube networks, the devices acquired a ppm level sensitivity for detecting methane, a gas for which the devices were otherwise insensitive. Lu et al. discloses sputter deposition of Pd onto nanotube powder followed by “shaking” and ultrasonic dispersion in purified water and subsequent drop drying across interdigitated microelectrodes. The reproducibility of devices made by such a method leaves much to be desired. For example, the amount of Pd loading was poorly controlled, as was the density of the nanotubes in the drop-dried networks bridging the electrodes of the device.

### SUMMARY

A multi-layer hydrogen sensor comprises a carbon nanotube comprising layer, and an ultra-thin metal or metal alloy layer disposed on the carbon nanotube comprising layer, wherein an electrical resistance of the layered sensor increases upon exposure to H₂. The carbon nanotube comprising layer preferably consists essentially of single wall nanotubes (SWNTs).

As used herein, the phrase “ultra-thin” corresponds to a thickness of from about 0.5 nm to about 10 nm. The ultra-thin layer can be a layer having uniform thickness, or be a sub-percolation layer of metal defined herein as a plurality of discrete, nanoscale metal islands, not in themselves electrically connecting by metal to one another, or a plurality of nanoscale metal islands wherein at least a portion of the nanoscale metal islands are electrically connected other islands by metal. In the case where the metal islands are not electrically connected to form a low resistance electrical path from one end of the sensor to the other, the thickness of the metal islands can be on the order of hundreds of nuns, or more, since such an arrangement will not shunt the carbon nanotube comprising active sensing layer.

The thickness of the ultra-thin metal or metal alloy layer is preferably from 0.5 to 5 nm thick. The ultra-thin metal or metal alloy layer can be selected from Ni, Pd, Pt, Ti, Ag and W, or mixtures thereof. In a preferred embodiment, the ultra-thin metal or metal alloy layer comprises Pd.

The thickness of the carbon nanotube comprising layer is preferably from 4 to 60 nm, such as from 4 to 10 nm. The interface between the carbon nanotube comprising layer and the ultra-thin metal or metal alloy layer is preferably characteristic of an evaporated interface or other low energy deposition process.

In a related embodiment that can provide integrated microsensors formable generally using conventional integrated circuit processing steps, the sensor further comprises an integrated circuit substrate, wherein the sensor is disposed on the substrate. At least one electronic device can be disposed on the substrate, the electronic device coupled to an output of the sensor.

A method of forming a layered hydrogen sensor comprises the steps of providing a substrate, forming an active sensor region on the substrate, the active sensor region comprising a carbon nanotube comprising layer disposed on or under an ultra-thin metal or metal alloy layer, and forming contacts to the active sensor region on either side of the active sensor region. The ultra-thin metal or metal alloy layer can be formed using an evaporation process, or other low energy deposition process.

The forming step can comprise forming the carbon nanotube comprising layer on a porous support layer, placing the carbon nanotube comprising layer on the porous support layer on the substrate, and then removing the support layer. The support layer can comprises a porous membrane. The nanotube comprising layer on the support layer can be formed using the steps of dispersing a plurality of nanotubes into a solution, the solution including at least one surface stabilizing agent for preventing the nanotubes from flocculating out of suspension, applying the solution to the porous support, and removing the solution, wherein the nanotubes are forced onto a surface of the porous support.

### BRIEF DESCRIPTION OF THE DRAWINGS

A fuller understanding of the present invention and the features and benefits thereof will be obtained upon review of the following detailed description together with the accompanying drawings, in which:

FIG. 1 shows an exemplary multi-layer H₂ sensor according to an embodiment of the invention.

FIG. 2 shows an integrated sensing system including a wireless transmitter on chip, according to an embodiment of the invention.

FIG. 3 shows a scanned image of the wired up H₂ sensor used to acquire data presented in the Examples described herein.

FIG. 4(a) shows resistance as a function of time for sensors according to the invention using a 25 nm SWNT layer both with and without Pd coatings, respectively; FIG. 4(b) shows the relative responses or sensitivities (ΔR/R) obtained using a 5 minute exposure to 500 ppm H₂ in N₂, for the Pd coated sensor.

FIG. 5(a)-(b) show the switching and recovery characteristics of H₂ sensing, as manifested in the change in ΔR/R at fixed applied voltage (0.5V), while FIG. 5(c) compares the exposure/recovery response of sputtered and thermally evaporated Pd layers on 7 nm thick SWNT films.

### DETAILED DESCRIPTION

It has been discovered that although electronic transport across pure SWNT films is relatively insensitive to the presence of H₂, electronic transport across the SWNT films become sensitive to H₂ if thin layers of certain metals, such as Pd, are present on the SWNT layer. A multi-layer H₂ sensor according to the invention comprises a carbon nanotube comprising layer, and a ultra-thin metal or metal alloy layer in contact with the nanotube layer. An electrical resistance of the layered sensor increases upon exposure to H₂. The metal or metal alloy layer is preferably selected from the group consisting of Ni, Pd and Pt, or mixtures thereof. However, other metals or metal alloys that provide good sensitivity may also be used, including, but not limited to, Ti, Ag, and W. As defined herein, sensitivity is defined as the change in resistance of the layered sensor (AR) divided by the initial resistance prior to exposure to the H₂-containing ambient (R). Sensors according to invention provide detection of ppm levels of hydrogen gas (H₂) down to at least 10 ppm, and can be conveniently operated at room temperature.

In a preferred embodiment, the carbon nanotube comprising layer consists essentially of single wall nanotubes (SWNTs). SWNTS are preferred because the inner layers in multi-walled nanotubes (MWNTs) are protected by the outer layer and will not respond to hydrogen interaction with the outer layer. Thus, the initial R will be larger and the AR upon hydrogen exposure smaller upon exposure H₂ for MWNTs, and thus lower sensitivity as compared to SWNTs. Although the invention is described using the preferred SWNTs, MWNTs, or mixtures of SWNTs and MWNTs may also be used, although these embodiments will generally yield a reduced device sensitivity.

As noted above, the thickness of the ultra-thin layer corresponds to a thickness of from about 0.5 nm to about 10 nm and can be embodied as a layer having uniform thickness, or a sub-percolation layer comprising a plurality of metal islands, where some or all the metal islands can be connected by metal. The thinner the metal or metal alloy layer, the higher the resulting sensitivity of the sensor since the active sensing nanotube layer is shunted by the metal or metal alloy layer generally disposed thereon or disposed thereunder. As noted above, in the case where the metal islands are not electrically connected to form a low resistance electrical path from one end of the sensor to the other, the thickness of the metal islands can be on the order of hundreds of nms, or more, since such an arrangement will not shunt the carbon nanotube comprising active sensing layer. Moreover, if maximum sensitivity is not required, a thicker metal or metal alloy layer, such as 10 nm to 200 nm, or more, may be used with the invention.

Conductance or resistance of the coated SWNT layer sensor can be conveniently measured. In a preferred embodiment, conductance is measured by measuring the change in current between two electrodes which contact opposing sides of the metal-coated SWNT sensor upon exposure to H₂ to determine the presence of H₂, and once calibrated, the concentration of H₂.

An important advantage of the invention relates to reusability. Sensors according to the invention have been found to quickly recover their initial film conductance upon exposure to air or other ambient having little or no H₂. For example, it has been found that most of the initial film conductance can be recovered in as little as 30 seconds in air.

Another attractive feature of sensors according to the invention is the low power consumption, which allows batteries to be used to provide power for sensor measurements. Power consumption can be on the order of 0.25 mW. This low power requirement is in part due to the lack of need for heating the sensor as must be done for catalytic bead and semiconducting oxide sensors. This power requirement could be reduced still further by pulsed operation. Moreover, sensors according to the invention have a simple structure, and can be measured using simple measurement arrangements as described below.

The interface between the SWNT layer and the nanoscale metal or metal alloy layer is preferably characteristic of an evaporated interface, or other low energy deposition process that does not significantly damage the nanotube layer. This finding was based on measurements that indicated that sputter deposition of metals onto the nanotubes may result in damage to the nanotube layer, while thermal evaporation of metals does not result in appreciable damage. Sputtered species generally have energies significantly higher than evaporated species, likely causing damage to the nanotube layer and potentially significant penetration depths.

Methods other than evaporation and sputtering may be used to deposit the ultra-thin metal or metal alloy layer, including, but not limited to, electrochemical or electroless deposition. For example, metal deposition could be performed electrochemically, utilizing the electrical conductivity of the nanotubes to act as the electrode upon which the electrodeposition takes place. Alternatively electroless deposition may also be employed with the nanotubes as the template upon which the deposition occurs.

A preferred method of forming thin (2 to 60 nm, such as 7 to 25 nm) SWNT films which have highly uniform thickness for use with the invention is described in commonly owned U.S. patent application Ser. No. 10/622,818 entitled “Transparent electrodes from single wall carbon nanotubes” filed on Jul. 18, 2003 ('818) and published on Oct. 7, 2004 as Published App. No. 20040197546. The transparent aspect of the nanotube films provided is generally not utilized in the present invention. However the high level of electrical interconnectedness of the nanotubes in the films generated using the process described in '818 which provides very high electrical conductivity, maximizes the sensitivity of sensors according to the invention to H₂ because nanotubes not electrically connected with other nanotubes do not contribute to the sensitivity of the device. The uniform SWNT film thickness provided using the process described in '818 moreover provides a uniformity of metal association with the SWNT film, thereby maximizing the sensitivity of the device, defined as noted above as the change in resistance AR (upon exposure to H₂) divided by the initial resistance (R) of the metallized SWNT film (ΔR/R).

Briefly, a dilute surfactant-suspension of SWNTs is vacuum filter onto a mixed cellulose ester (MCE) filtration membrane (0.1 μm pore size, Millipore). The SWNTs are preferably purified pulsed-laser-vaporization grown SWNTs. However, SWNTs can be grown by any method. For example, moderately dense SWNTs can be grown on a surface as an inter-connected network as disclosed by Snow E S, Novak J P, Campbell P M, Park D. Appl Phys Lett 2003; 82:2145. The nanotubes deposit as a thin film on the membrane. Washing with purified water removes the surfactant. Once dried, the membrane with the SWNT film attached is cut to the desired size (e.g. 3 mm×8 mm), wetted with pure water again, and the film side placed against the substrate (e.g. 600 nm thermal SiOₓ/Si wafer) to which the SWNT film transfer is to be made. The substrate and membrane are sandwiched between wicking filter paper situated between metal plates and pressure is applied via spring clamps. Once the assembly is nearly dry (accelerated by oven heating at 95° C.) the film and membrane adhere sufficiently to the substrate to permit transfer to an acetone vapor bath. Acetone condensing onto the MCE membrane in the vapor bath dissolves it away, leaving only the SWNT film adhered to the substrate. These films are preferably subsequently baked in inert atmosphere at a fairly high temperature, such as 600° C., to desorb residual contaminants and charge transfer nanotube dopants.

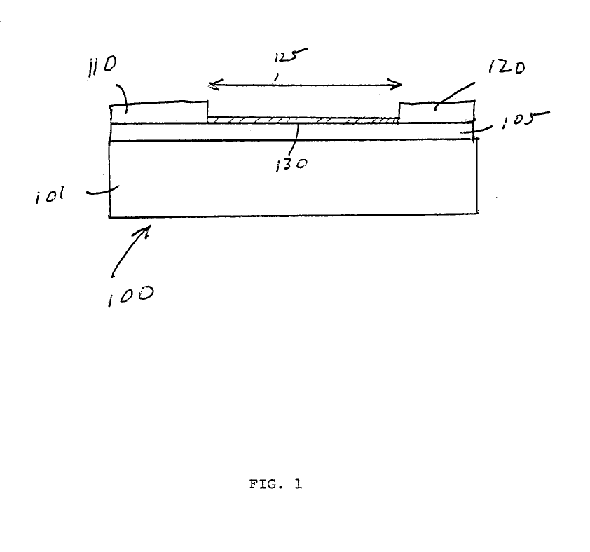

FIG. 1 shows an exemplary H₂ sensor 100 according to an embodiment of the invention built on a substrate 101. Substrate 100 which provides mechanical support for sensor 100 can be an electrically insulating material, or semiconducting or metal material. However, when a semiconducting or metal substrate is used, a dielectric layer such as SiO₂ (not shown) will generally be disposed between the substrate and the active layers of sensor 100. Nanotube comprising layer 105 is disposed on substrate 100.

Sensor 100 includes contact electrodes 110 and 120 disposed on top of the nanotube comprising layer 105. Contact electrodes can be deposited using either sputtering or thermal evaporation. However, as noted above, evaporation is preferred. Nanotube comprising layer 105 is preferably a SWNT film having a highly uniform thickness from 7 to 25 nm as described in '818. However, the invention is not limited to SWNT layers described in '818.

Although the resulting arrangement is not shown in FIG. 1, contact electrodes 110 and 120 can be pre-deposited on the substrate 101 followed by deposition of the nanotube film comprising layer 105. The contact electrode thickness should be sufficiently thick to provide a low resistance contact, such as 500 Å of a metal. Between the contact electrodes 110 and 120 is the active sensor region 125 of sensor 100 which includes the nanotube comprising film 105. An ultra-thin layer 130 of Pd, Pt or Ni is disposed across active sensor region 125 so that the active sensor portion 125 is coated with the ultra-thin metal. In another embodiment of the invention, the surface of the entire sensor 100 is coated with the ultra-thin metal layer 130.

Although sensor devices described above are described as being macroscopic, such as sensor 100 shown in FIG. 1, sensors according to the invention can be microscopic, such as disposed on chip along with associated electronics. For example, SWNT films can readily be patterned by standard lithographic techniques (see K. Lee, Z. Wu, Z. Chen, F. Ren, S. J. Pearton, A. G. Rinzler, Nano Lett. 4, 911 (2004). This allows miniaturization and mass production which should result in hydrogen sensors according to the invention requiring still less power, as well as low cost as compared to macroscopic embodiments.

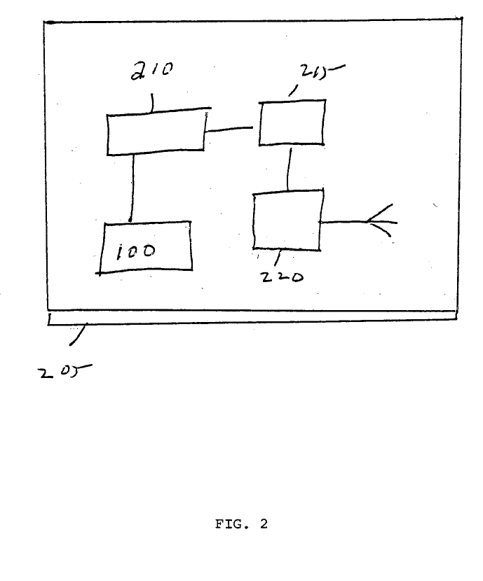

FIG. 2 shows an exemplary H₂ microsensor 200 according to the invention disposed on chip, such as on a Si wafer 205 adapted for remote sensing. Signals from microsensor 100 are filtered by filter 210, then amplified by amplifier 215. The output of amplifier is fed to wireless transmitter 220 which drives antenna 225 which is shown as an on chip antenna 225. Filter 210, amplifier 215, wireless transmitter 220 and antenna 225 are all disposed on Si wafer 205. A battery pack (not shown) can be adhered to the back of the die for providing the energy needed to power the various components of microsensor 200.

In another related embodiment, integrated sensing systems according to the invention can be conveniently mounted in locations of interest, such as near H₂ sources and associated H₂ supply lines. Such systems provide continuous, automatic and real time (or near real-time) detection of H₂ in the surrounding environment. The conductance measurements provided by sensor 200 are communicated to a processor (not shown). Processor can include associated non-volatile memory, such as for storing data manipulation algorithms, calibration data, or predetermined user programmable setpoints. Upon detection of more than a predetermined level of H₂ indicating possible danger, the system can provide a visual display or an audible alarm (not shown).

Systems according to the invention can be positioned at several locations along a H₂ supply line which provides fuel to an electrochemical generator, such as a PEM fuel cell. In a preferred embodiment, the system includes a valve which when closed turns off the supply of H₂ to the electrochemical generator. Upon the detection of H₂ above a predetermined level using sensors according to the invention, a sequence of events can be initiated to close the valve.

Although not shown, sensors according to the invention can be part of sensor arrays which detect not only H₂, but other species as well. The other sensors in the array can also be thin film sensors, electrochemical sensors, or other sensor types.

### EXAMPLES

The present invention is further illustrated by the following specific Examples, which should not be construed as limiting the scope or content of the invention in any way.

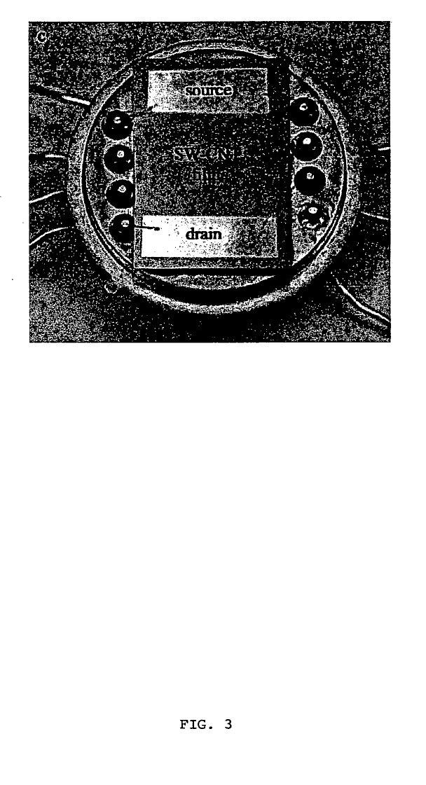

FIG. 3 shows a scanned image of the wired up H₂ sensor used to acquire data presented in the Examples. The H₂ sensor included two contacts, denoted as “source” and “drain”, and an active sensor region denoted as “SW-CNT film”. Experiments were performed with and without the ultra-thin metal or metal alloy layer disposed on the active sensor region as described below. The power supply used in the experiments performed is not shown in FIG. 3.

Sample exposure to gasses including H₂ was performed at room temperature and atmospheric pressure in a quartz flow tube with electrical feed-throughs for voltage and current leads. The gasses were fed via mass flow controllers to maintain a total flow of 450 sccm of either pure nitrogen, 500 ppm H₂ in N₂, or a mixture of the two to obtain reduced concentrations of H₂, or air. Electrical measurements were performed using an HP4156B source-meter. Excitation voltages ranged ±0.5 V For I-V measurements and were held at 0.5 V for current-time measurements.

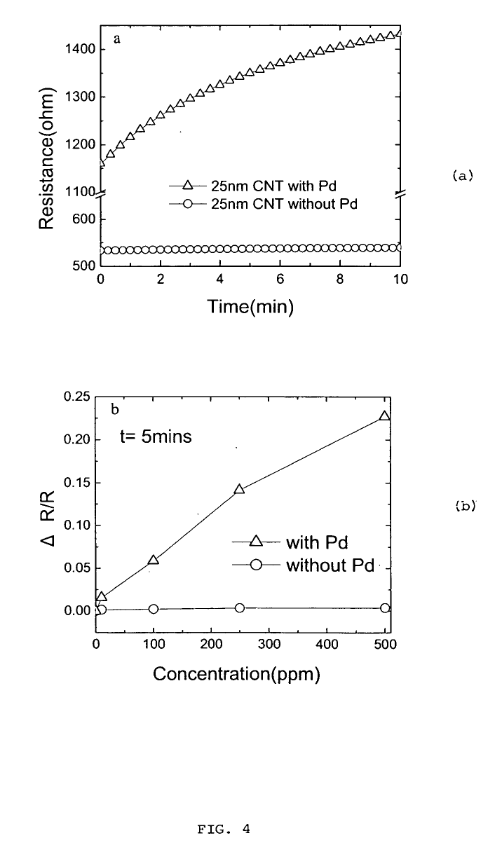

FIG. 4(a) show resistance as a function of time for sensors according to the invention using 25 nm thick SWNTs both with and without Pd coatings, respectively. Although the sensors including the Pd showed a significant response to 500 ppm H₂ in N₂, the no Pd control did not show any detectable response. FIG. 4(b) shows the relative responses or sensitivities defined as the change in resistance divided by the initial resistance prior to H₂-containing ambients (ΔR/R) after a 5 minute exposure to 500 ppm H₂ in N₂, for the Pd coated sensor. The ΔR/R was 6% at 100 ppm and 23% at 50 ppm as shown in FIG. 4(b).

Over the concentration range investigated, there was an essentially linear dependence of ΔR/R on H₂ concentration, with a slope of about 0.04%/ppm of H₂. The detection limit of the 25 nm films for measurement times of about 10 minutes following exposure for sensors according to the invention was found to be about 10 ppm H₂ at room temperature.

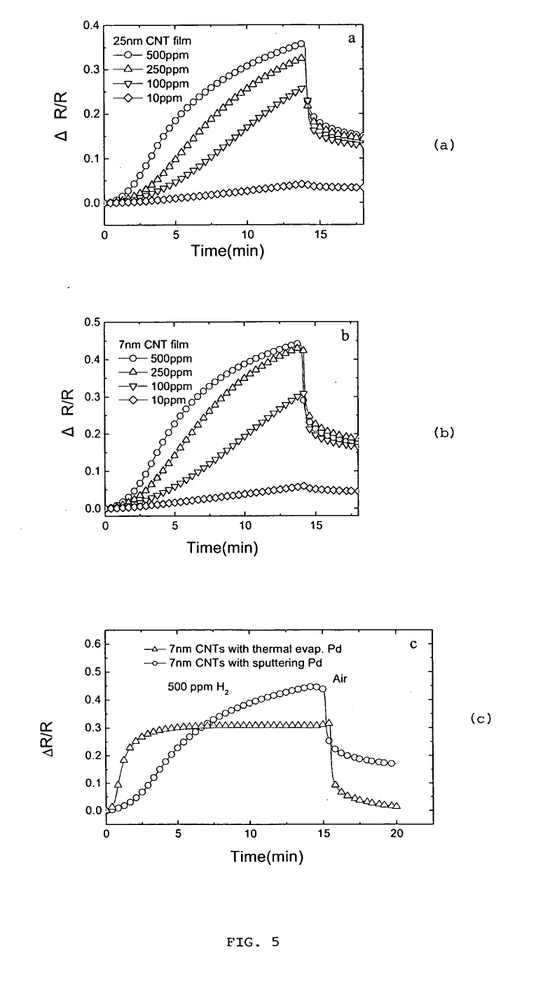

FIG. 5(a)-(b) shows the switching and recovery characteristics of H₂ sensing, as manifested in the change in ΔR/R at fixed applied voltage (0.5V). During the first 15 minutes of testing, the sensors were exposed to 500 ppm H₂ in N₂. After 15 minutes, the sensors were recovered in air. FIGS. 5(a) and 5(b) show ΔR/R for sputtered 25 nm and 7 nm sensor films according to the invention, respectively. The fractional response (ΔR/R) of the 7 nm film is seen to be greater than that of the 25 nm film evidencing the improved sensitivity for thinner films.

FIG. 5(c) compares the exposure/recovery response of sputtered and thermally evaporated Pd layers on 7 nm SWNT films. As noted above, the recovery tests from H₂ exposure used air, which has been observed to result in a faster and more complete recovery. The thermally evaporated film is seen to have a substantially faster response in both exposure and recovery, although the overall signal is somewhat smaller than that for the sputter coated sample, which could be due to small differences in the thickness of the thin Pd layers in the respective cases.

It is to be understood that while the invention has been described in conjunction with the preferred specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

We claim:

1. A multi-layer hydrogen sensor, comprising:
a carbon nanotube comprising layer, and
an ultra-thin metal or metal alloy layer disposed on said carbon nanotube comprising layer, wherein an electrical resistance of said layered sensor increases upon exposure to H₂.

2. The sensor of claim 1, wherein said carbon nanotube comprising layer consists essentially of single wall nanotubes (SWNTs).

3. The sensor of claim 1, wherein said ultra-thin metal or metal alloy layer is selected from the group consisting of Ni, Pd, Pt, Ti, Ag, and W, or mixtures thereof.

4. The sensor of claim 1, wherein said ultra-thin metal or metal alloy layer comprises said Pd.

5. The sensor of claim 4, wherein a thickness of said carbon nanotube comprising layer is from 4 to 60 nm.

6. The sensor of claim 5, wherein said thickness of said carbon nanotube comprising layer is from 4 to 10 nm.

7. The sensor of claim 1, wherein said ultra-thin metal or metal alloy layer is from 10 to 50 angstroms thick.

8. The sensor of claim 1, wherein an interface between said carbon nanotube comprising layer and said ultra-thin metal or metal alloy layer is characteristic of an evaporated interface.

9. The sensor of claim 1, further comprising an integrated circuit substrate, wherein said sensor is disposed on said substrate.

10. The sensor of claim 9, further comprising at least one electronic device disposed on said substrate, said electronic device coupled to an output of said sensor.

11. A method of forming a layered hydrogen sensor, comprising the steps of:
providing a substrate;
forming an active sensor region on said substrate, said active sensor region comprising a carbon nanotube comprising layer disposed on or under an ultra-thin metal or metal alloy layer, and
forming contacts to said active sensor region on either side of said active sensor region.

12. The method of claim 11, wherein said ultra-thin metal or metal alloy layer is selected from the group consisting of Ni, Pd, Pt, Ti, Ag and W, or mixtures thereof.

13. The method of claim 11, wherein said ultra-thin metal or metal alloy layer comprises said Pd.

14. The method of claim 11, wherein a thickness of said carbon nanotube comprising layer is from 2 to 30 nm.

15. The method of claim 11, wherein said forming step comprises forming said carbon nanotube comprising layer on a porous support layer, placing said carbon nanotube comprising layer on said porous support layer on said substrate, and removing said support layer.

16. The method of claim 15, wherein said support layer comprises a porous membrane.

17. The method of claim 15, wherein said nanotube comprising layer on said support layer is formed using the steps of:
dispersing a plurality of nanotubes into a solution, said solution including at least one surface stabilizing agent for preventing said nanotubes from flocculating out of suspension;
applying said solution to said porous support, and
removing said solution, wherein said nanotubes are forced onto a surface of said porous support.

18. The method of claim 11, wherein said ultra-thin metal or metal alloy layer is formed using an evaporation process.

19. The method of claim 11, wherein said ultra-thin metal or metal alloy layer is from 10 to 50 angstroms thick.
